(19) United States
(12) Patent Application Publication
(10) Pub. No.: US 2011/0307439 A1
(43) Pub. Date: Dec. 15, 2011

(54) METHODS AND APPARATUS FOR DISPLAYING PREDICTIONS ASSOCIATED WITH AN ALPHABETIC STRING

(75) Inventor: Mark Christopher Evans, Pleasant Hill, CA (US)

(73) Assignee: XOMA TECHNOLOGY LTD., Berkeley, CA (US)

(21) Appl. No.: 13/140,558

(22) PCT Filed: Dec. 17, 2009
(86) PCT No.: PCT/US09/68517

§ 371 Date: Aug. 30, 2011

Related U.S. Application Data
(60) Provisional application No. 61/138,408, filed on Dec. 17, 2008.
(60) Provisional application No. 61/138,411, filed on Dec. 17, 2008.

(51) Int. Cl. G06N 5/04

(52) U.S. Cl. 706/52

(57) ABSTRACT

The present disclosure provides methods and apparatus for displaying an alphabetic string representing an amino acid sequence of an antibody in association with predicted characteristics of certain sites in the antibody. In an embodiment, a process causes a web based application server to receive an alphabetic string from a client device indicative of an amino acid sequence. The server then predicts sites in the amino acid sequence likely to be associated with certain chemical properties such as deamidation, glycosylation, oxidation, proteolysis, and isomerization. The server may also predict other characteristics such as domain boundaries, binding sites, hydrophobicity levels, surface exposures, etc. The server then sends data to the client device indicative of the predicted sites and characteristics, so that the client device can display the alphabetic string indicative of the amino acid sequence with a graphical indication of the position of each predicted chemical property (e.g., with a semitransparent glyph over the associated alphabetic character).

### CROSS-REFERENCE TO RELATED APPLICATIONS

This application claims priority to U.S. Provisional Application No. 61/138,408, filed on Dec. 17, 2008 and U.S. Provisional Application No. 61/138,411, filed on Dec. 17, 2008, each of which is hereby incorporated by reference in its entirety.

### TECHNICAL FIELD

The present application relates in general to computer aided design software and more specifically to methods and apparatus for displaying chemical property predictions on an alphabetic string representing amino acid residues of an antibody.

### BACKGROUND

Engineers working with amino acid residues typically represent those residues using alphabetic representations of the amino acids. A three-letter and a single-letter system are in common use. For example, in the three-letter system, the amino acid residue Arginine is represented by “Arg.” In the single-letter system, the amino acid residue Arginine is represented by “R.”

Antibodies are comprised of chains of amino acids. Engineers working with antibodies typically represent these chains using alphabetic strings. For example, “QVTLK” may represent an amino acid chain including five amino acid residues. This five residue chain may represent a portion of an antibody. In practice, these alphabetic strings may be relatively long. For example, when a string represents an amino acid sequence encoding a human antibody heavy chain variable region, the string may include from about 120 to about 140 letters.

Engineers may edit these alphabetic strings. For example, an engineer may wish to edit (e.g., substitute, add, delete) certain letters in certain positions of the alphabetic strings. A number of methods to modify antibodies exist. For example, a detailed description of a method for modifying antibodies of any origin is provided in U.S. Pat. No. 5,766,886 the contents of which are incorporated herein by reference.

Alternatively, or in addition, an engineer may wish to utilize these alphabetic strings to see which amino acid sites in the antibody are likely to be associated with certain characteristics such as specific chemical properties. In some instances, the engineer may wish to see such amino acids sites likely to be associated with certain characteristics such as specific chemical properties, in the context of a linear alphabetic string. In other instances, the engineer may wish to see such amino acid sites likely to be associated with certain characteristics such as specific chemical properties in the context of a multi-dimensional alphabetic string. For example, the surface exposure of the represented amino acids of an antibody may be shown in association with the amino acid sites. In this manner, a design approach can be used instead of a trial and error approach.

However, existing systems for displaying amino acid sites likely to be associated with certain characteristics suffer from certain drawbacks. For example, existing systems may simply output a table of numbers indicative of amino acid sites and associated chemical properties. Some existing systems output a graph indicative of amino acid sites and associated chemical properties. When an engineer is attempting to view multiple characteristics (e.g., specific chemical properties, domains, bindings, hydrophobicity, surface exposure, etc.), the associated amino acid sites, and the relationship between these multiple characteristics and sites, the engineer may need to alternate between several different tables and graphs in potentially different formats to mentally assemble the relationship between these variables. In some cases, important spatial relationships between characteristics of an amino acid sequence are never discovered. Additionally, for some amino acid sites likely to be associated with certain characteristics as predicted by existing systems that use only a linear alphabetic string, the likelihood of those predicted characteristics may decrease in the context of a multi-dimensional or folded alphabetic string. Accordingly, in the present system, the surface exposure of the represented amino acids of an antibody are shown.

### SUMMARY

The present disclosure provides methods and apparatus for displaying alphabetic strings that represent amino acid sequences comprising amino acid residues of an antibody in association with predicted characteristics, such as specific chemical properties, of certain sites in the antibody. In an embodiment, a process causes a web based application server to receive an alphabetic string from a client device indicative of an amino acid sequence. The server then predicts sites in the amino acid sequence likely to be associated with certain characteristics such as for example, deamidation, glycosylation, oxidation, proteolysis, isomerization, domains, bindings, hydrophobicity, surface exposure, etc. The server then sends data to the client device indicative of the predicted sites, so that the client device can display the alphabetic string indicative of the amino acid sequence with a graphical indication of the position of each predicted chemical property (e.g., with a semitransparent glyph over the associated alphabetic character).

The server may also send data to the client device to facilitate the display of other properties associated with the amino acid sequence. For example, the server may send data indicative of hydrophobicity, domain boundaries, binding sites, surface exposure, and/or an isoelectric point based on surface exposure.

Although a client-server architecture is used in the examples herein, a stand-alone computer architecture may also be used. In such an instances the functions performed by both the client and the server in the described client server architecture are instead performed by a stand-alone computer device.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a system for displaying alphabetic strings and associated chemical property predictions.

FIG. 4 is a screen shot of an example user interface for displaying alphabetic strings indicative of a light chain and associated chemical property predictions.

FIG. 5 is another screen shot of an example user interface for displaying alphabetic strings indicative of a light chain and associated chemical property predictions.

FIG. 6 is another screen shot of an example user interface for displaying alphabetic strings indicative of a heavy chain and associated chemical property predictions.

FIG. 7 is a close up view of an example user interface showing overlapping glyphs.

FIG. 8 is a close up view of an example user interface showing a high hydrophobicity sequence in combination with a buried surface exposure.

FIG. 9 is a close up view of an example user interface showing a low hydrophobicity sequence in combination with an outward and buried surface exposure.

FIG. 10 is an example table showing single letter representations of twenty amino acid residues.

### DETAILED DESCRIPTION

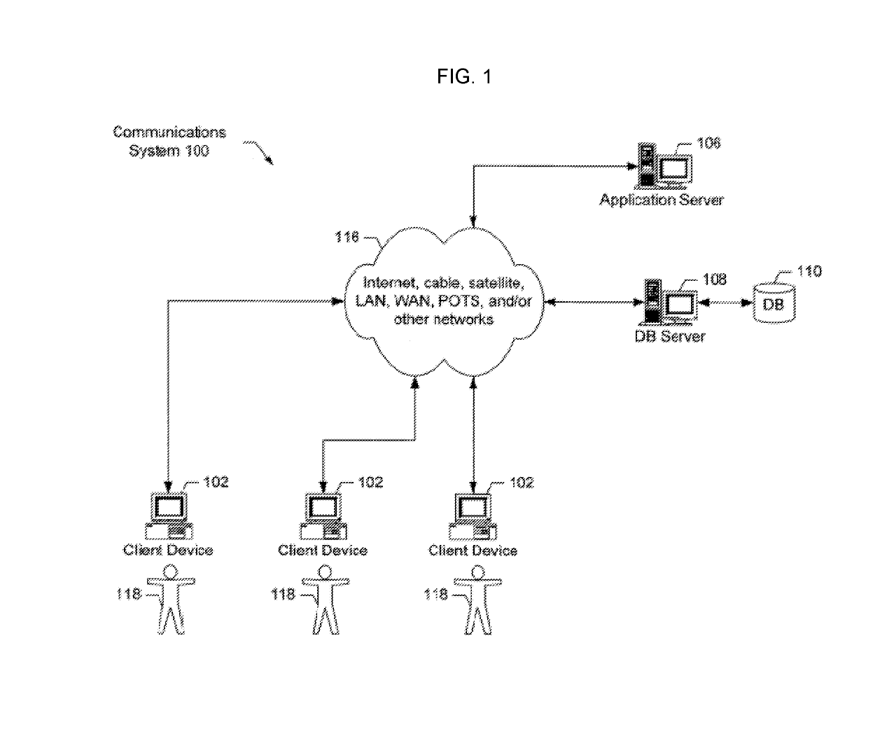

The present system is most readily realized in a network communications system. A high level block diagram of an exemplary network communications system 100 is illustrated in FIG. 1. The illustrated system 100 includes one or more client devices 102, one or more application servers 106, and one or more database servers 108 connected to one or more databases 110. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

One application server 106 may interact with a large number of client devices 102. Accordingly, each application server 106 is typically a high end computing device with a large storage capacity, one or more fast microprocessors, and one or more high speed network connections. Conversely, relative to a typical application server 106, each client device 102 typically includes less storage capacity, less processing power, and a slower network connection.

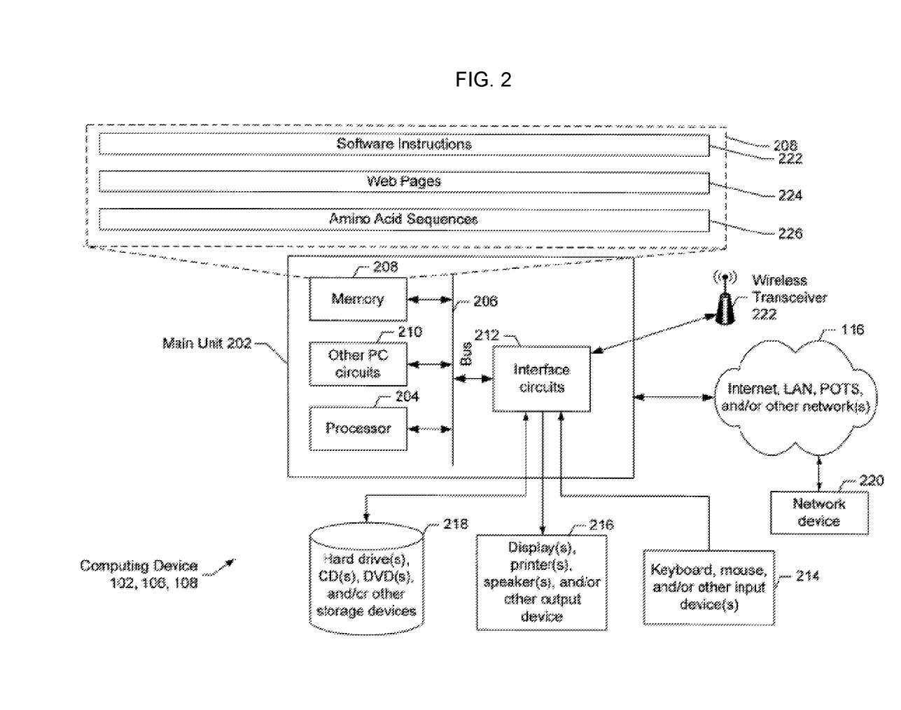

A detailed block diagram of an example computing device 102, 106, 108 is illustrated in FIG. 2. Each computing device 102, 106, 108 may include a server, a personal computer (PC), a personal digital assistant (PDA), and/or any other suitable computing device. Each computing device 102, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions 222 that interact with the other devices in the system 100 as described herein. These software instructions 222 may be executed by the processor 204 in any suitable manner. The memory 208 and/or another storage device 218 may also store one or more data structures, digital data indicative of documents, files, programs, web pages, etc. retrieved from another computing device 102, 106, 108 and/or loaded via an input device 214.

The example memory device 208 stores software instructions 222, web pages 224, and alphabetic strings representing amino acid sequences comprising amino acid residues of an antibody 226 for use by the system as described in detail below. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the computing device 102, 106, 108. For example, the display 216 may be used to display web pages received from the application server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 106, 108.

Each computing device 102, 106, 108 may also exchange data with other computing devices 102, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users 118 of the system 100 may be required to register with the application server 106. In such an instance, each 118 user may choose a user identifier (e.g., e-mail address) and a password which may be required for the activation of services. The user identifier and password may be passed across the communication channel(s) 116 using encryption built into the user's browser, software application, or computing device 102, 106, 108. Alternatively, the user identifier and/or password may be assigned by the application server 106.

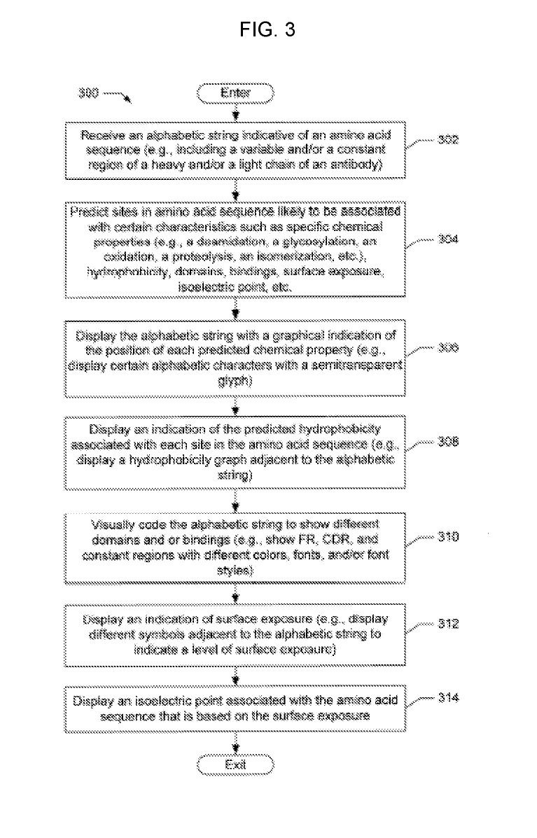

A flowchart of an example process 300 for displaying predicted sites for modification of an antibody is presented in FIG. 3. Preferably, the process 300 is embodied in one or more software programs which are stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, some of the steps described may be optional, and additional steps may be included. For example, the process 300 may include a step of producing one or more of the amino acid sequences represented by the alphabetic strings.

In general, the process 300 causes an application server 106 to receive an alphabetic string from a client device 102 indicative of an amino acid sequence. The server 106 then predicts sites in the amino acid sequence likely to be associated with certain characteristics, e.g., chemical properties or modification sites, such as for example, deamidation, glycosylation, oxidation, proteolysis, isomerization, etc. Alternatively or in addition, the server 106 predicts additional characteristics, such as for example, domains, binding sites, hydrophobicity, surface exposure, etc, that may be associated with the amino acid sequence. The server 106 then sends data to the client device 102 indicative of the predicted sites, so that the client device 102 can display the alphabetic string indicative of the amino acid sequence with a graphical indication of the position of each predicted chemical property (e.g., with a semitransparent glyph over the associated alphabetic character).

More specifically, the application server 106 begins the example process 300 by receiving an alphabetic string indicative of an amino acid sequence (block 302). For example, a user 118 may enter the alphabetic string using an input device 214 of a client device 102, or the user 118 may retrieve the alphabetic string from a database, such as a database stored on the client device 102 or a network device 220 (e.g., the IMGT germ line sequence database, the Kabat database, etc.). The application server 106 may then receive the alphabetic string from the client device 102 via a network 116, such as the Internet. The amino acid sequence represented by the alphabetic string may include a variable region and/or a constant region of a heavy chain and/or a light chain of an antibody (e.g., an antibody or fragment thereof such as an IgG, a Fab or a scFv). In some embodiments, the alphabetic string may include a partial or full-length heavy and/or light chain of an antibody. In some embodiments, the alphabetic string may include a variable region of a heavy and/or light chain of an antibody. In some embodiments, the alphabetic string may include a variable region of a heavy chain and/or one or more constant regions of a heavy chain (e.g. C_{H}1, C_{H}2 and/or C_{H}3) and/or a variable region of a light chain and/or a constant region of a light chain (e.g., C_{L}) of an antibody. In some embodiments, the alphabetic string may include two full-length heavy chains and/or two full-length light chains of an antibody.

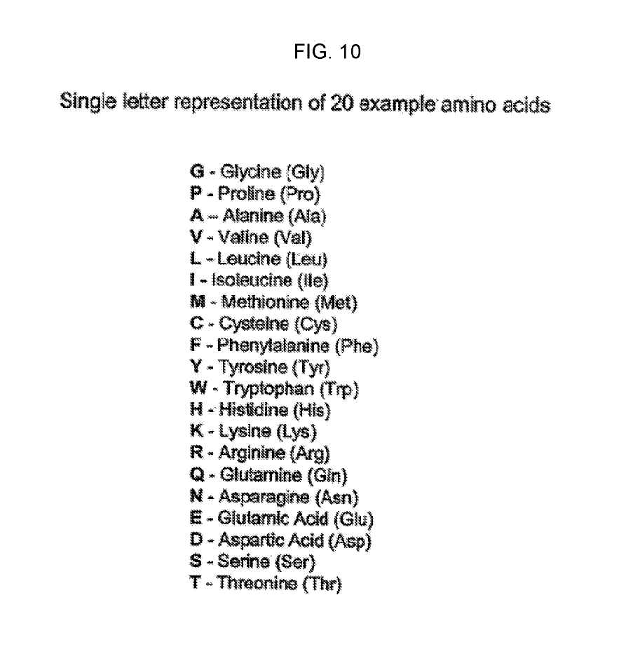

A table showing example single letter representations for each of twenty amino acid residues is illustrated in FIG. 10. It will be appreciated that other symbols may be used to represent these and/or other amino acid residues. For example, symbols for non-standard amino acids may be used, user defined symbols may be used, and/or symbols indicative of ambiguities may be used.

Once the application server 106 receives the alphabetic string indicative of the amino acid sequence, the application server 106 preferably executes one or more algorithms to predict sites in the amino acid sequence likely to be associated with certain characteristics (block 304). For example, the application server 106 may predict one or more sites in the amino acid sequence associated with a deamidation, a glycosylation, an oxidation, a proteolysis, and/or an isomerization. In addition, the application server 106 may predict domain boundaries, binding sites, hydrophobicity levels, surface exposures, etc.

Preferably, regular expressions and/or any other suitable string pattern matching techniques are used to determine some of these predictions. For example, one or more of the following regular expressions may be used:

| | |
|---|---|
| Deamidation | N[GHSDAR] |
| Glycosylation | N[\hat{ }P][ST] |
| Oxidation | M |
| Isomerization | DG |
| OmpT/ProteaseVII | [RK][RK] |
| Protease Do (degP/htrA) | [VL] |
| Methionine aminopeptidase | MA[PM]L |

Data indicative of these predictions, as well as other data discussed below, is then sent from the application server 106 to the client device 102 via the network 116. For example, the application server 106 may dynamically generate web page data. The web page data may be any suitable type of web page data. For example, the web page data may include Hypertext Markup Language (HTML), JavaScript, and/or Java. Although the examples described herein use an application server 106 and a client device 102, it will be appreciated that all of the methods described herein may be similarly executed on a stand alone computing device.

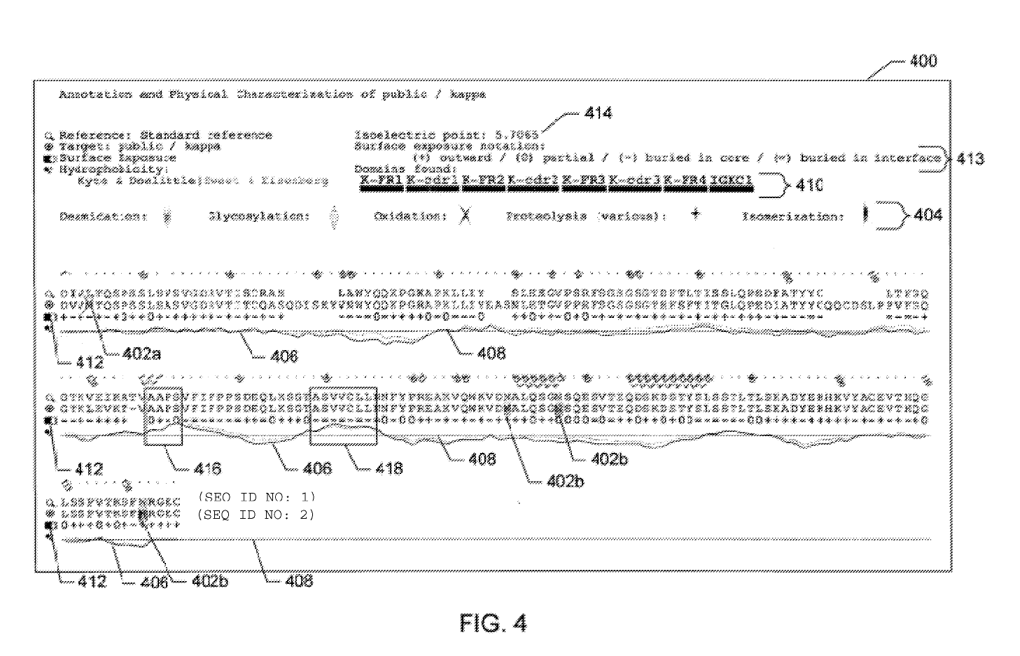

Once the data from the server 106 is received, the client device 102 displays the alphabetic string with a graphical indication of the position of each predicted chemical property (block 306). For example, the client device 102 may display certain alphabetic characters with a semitransparent glyph 402 as shown in FIG. 4. In the example screen shot 400 of FIG. 4, a first glyph 402a having a first color and a first shape is used to indicate a site in the example amino acid sequence likely to be associated with an oxidation. In addition, this example shows a second different glyph 402b having a second different color and a second different shape being used to indicate three different sites in the example amino acid sequence likely to be associated with an deamidation.

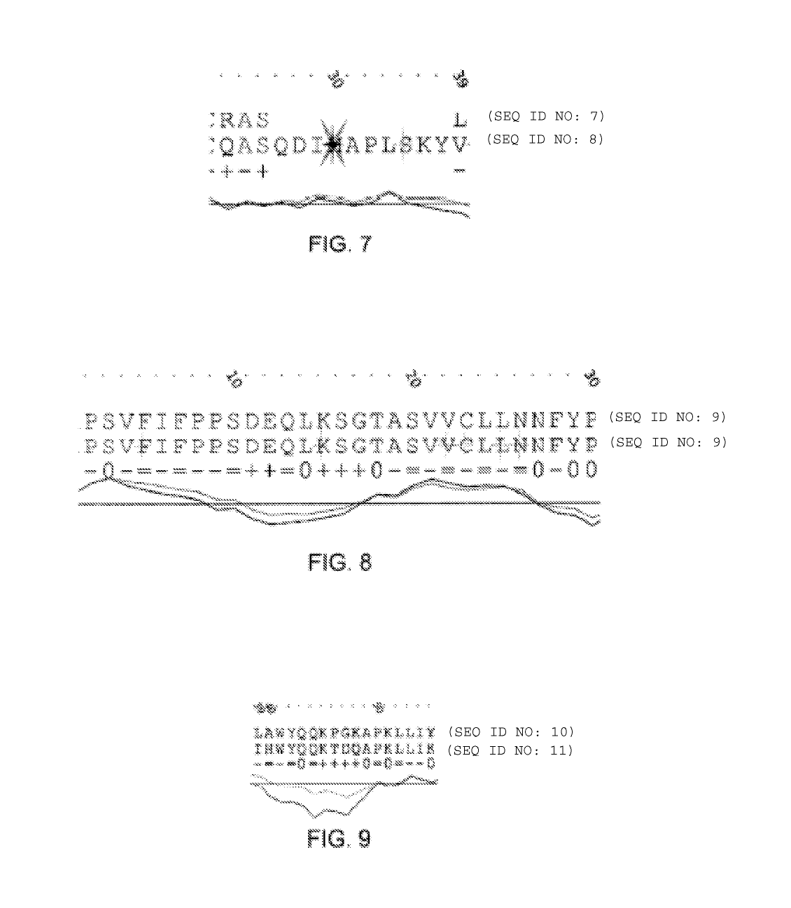

By making the glyphs different shapes, the same amino acid site may be labeled with multiple chemical properties without one glyph completely obscuring another glyph. For example, FIG. 7 is a close up view of an example user interface showing two overlapping glyphs. Other glyphs, shown in the glyph key 404, may be used to indicate other chemical properties associated with the amino acid sequence, such as glycosylation, proteolysis, and isomerization. It will be appreciated that many other chemical properties of an amino acid sequence may be determined and displayed in this manner.

It will be appreciated that any suitable graphical indication be used to indicate the position of each predicted chemical property. For example, the client device 102 may display certain alphabetic characters with different colors, fonts, and/or font styles to distinguish between different predicted chemical properties.

The client device 102 may also display an indication of the predicted hydrophobicity associated with each site within the amino acid sequence (block 308). For example, the client device 102 may display a hydrophobicity graph 406 adjacent to the alphabetic string as shown in FIG. 4. In this manner, the hydrophobicity graph 406 visually indicates the site in the amino acid sequence associated with each plotted hydrophobicity point. In this example, two hydrophobicity graphs 406 are shown. One of the hydrophobicity graphs 406 is based on the Kyte and Doolittle algorithm (Kyte, J. and Doolittle, R. F. “A simple method for displaying the hydropathic character of a protein”. J. Mol. Biol. 157, 105-132 (1982)), and the other hydrophobicity graph 406 is based on the Sweet and Eisenberg algorithm (Correlation of sequence hydrophobicities measures similarity in three-dimensional protein structure. Sweet R M, Eisenberg D. J Mol Biol. 1983 Dec. 25; 171(4):479-88).

The hydrophobicity graphs 406 are plotted along a center line 408. Sites of the amino acid sequence associated with a hydrophobicity graph 406 above the center line 408 tend to be hydrophobic sites, and sites of the amino acid sequence associated with a hydrophobicity graph 406 below the center line 408 tend to be hydrophilic sites. In some embodiments, data indicative of hydrophobicity is displayed without a graph. In some embodiments, the hydrophobicity data and/or graph is based on a sliding window moving average algorithm. It will be appreciated that graphs indicative of other characteristics may also be displayed adjacent to the alphabetic string to visually indicate the site in the amino acid sequence associated with each plotted point. In some embodiments, multiple characteristics may be displayed on the same axis in different colors and/or line styles.

The client device 102 may also visually code the alphabetic string to show different domains (block 310). For example, one or more framework regions (FRs), one or more complementarity determining regions (CDRs), one or more constant regions, and one or more hinge regions may be displayed with different colors, fonts, and/or font styles to distinguish between the regions. In one embodiment, a hidden Markov model (HMM) is used to determine domain boundaries. For example, the algorithms described in (1) Sean Eddy, HMMER User Guide—Biological sequence analysis using profile hidden Markov models Version 2.3.2 October 2003, Howard Hughes Medical Institute and Dept. of Genetics and (2) R. Durbin, S. Eddy, A. Krogh, and G. Mitchison, Biological sequence analysis: probabilistic models of proteins and nucleic acids, Cambridge University Press, 1998 may be used to determine domain boundaries.

Like domains, the client device 102 may also visually code the alphabetic string to represent other physical characteristics, such as binding sites. For example, the FcRn binding site may be displayed with different colors, fonts, and/or font styles to distinguish it from the Fc gamma binding site.

In the example of FIG. 4, a region key 410 indicates a color that is associated with each region, and that color is then used for the portion of the alphabetic string associated with that region. In some embodiments, the colors, fonts, and/or font styles are alternated between regions. For example, the first region may be color coded blue, the next region red, then blue, then red, etc. In some embodiments, each region receives a unique color, font, and/or font style. For example, the first region may be color coded red, the next region orange, then yellow, then green, etc.

The client device 102 may also display an indication of surface exposure (block 312). For example, the client device 102 may display different symbols adjacent to the alphabetic string to indicate a level of surface exposure. In the example of FIG. 4, a surface exposure row 412 includes a symbol for each amino acid site. Each symbol is indicative of a level of surface accessibility of the represented amino acid position. As shown in key 413, in this example, a plus sign (e.g., “+”) indicates that the represented amino acid in that position is outward and therefore highly accessible to the solvent. A zero sign (e.g., “o”) indicates that the represented amino acid in that position is partially buried. A negative sign (e.g., “−”) indicates that the represented amino acid in that position is completely buried in a subunit hydrophobic core. An equal sign (e.g., “=”) indicates that the represented amino acid in that position is completely buried in a subunit interface. The determination of surface exposure may be determined using either (1) a static method, in which the outcome has been determined beforehand or (2) a dynamic method, in which the outcome is calculated on the fly each time.

The client device 102 may also display an isoelectric point 414 associated with the amino acid sequence that is based on the surface exposure (block 314). For example, the client 102 and/or the server 106 may identify which amino acids in the amino acid sequence are near a surface of the antibody and which amino acids are not near the surface of the antibody (e.g., based on the data used to display the surface exposure row 412 generated by block 312). The isoelectric point 414 of the amino acid sequence may then be calculated using only the amino acids that are at and/or near a surface of the antibody (e.g., a surface pl). For example, the isoelectric point 414 may be calculated using just the amino acids associated with an outward exposure as indicated by the “+” symbol in the surface exposure row 412. Alternatively, the isoelectric point 414 may be calculated using just the amino acids associated with a partial exposure as indicated by the “o” symbol in the surface exposure row 412. In yet another example, the isoelectric point 414 may be calculated using just the amino acids associated with an outward exposure and a partial exposure as indicated respectively by the “+” symbol and the “o” symbol in the surface exposure row 412.

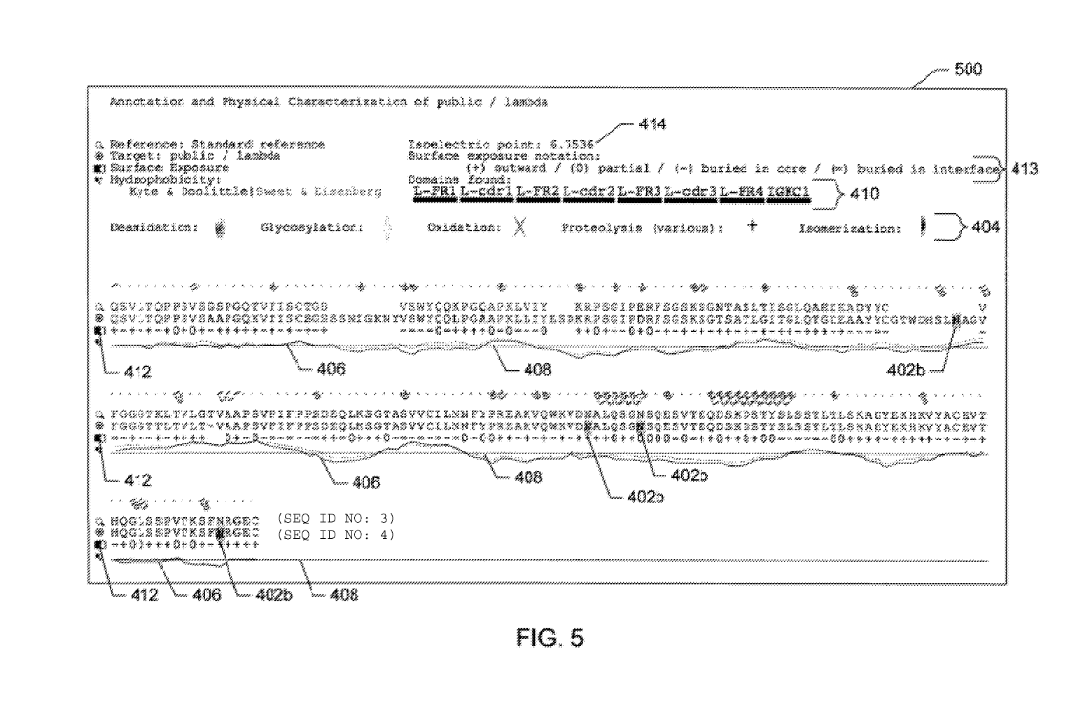

Another screen shot 500 of an example user interface for displaying alphabetic strings and associated chemical property predictions is shown in FIG. 5. In this example, several glyphs 402b are used to indicate different sites in the example amino acid sequence likely to be associated with a deamidation. As described above with reference to FIG. 4, other glyphs, shown in the glyph key 404, may be used to indicate other chemical properties associated with the amino acid sequence. Again, a hydrophobicity graph 406 plotted along a center line 408 and adjacent to the alphabetic string is shown. In addition, a region key 410 indicates a color that is associated with each region, and that color is then used for the portion of the alphabetic string associated with that region. Like the example of FIG. 4, the example of FIG. 5 includes a surface exposure row 412, which includes a symbol for each amino acid site indicative of a level of surface accessibility of the represented amino acid position. The example of FIG. 5 also includes an isoelectric point 414 associated with the amino acid sequence that may be based on the surface exposure.

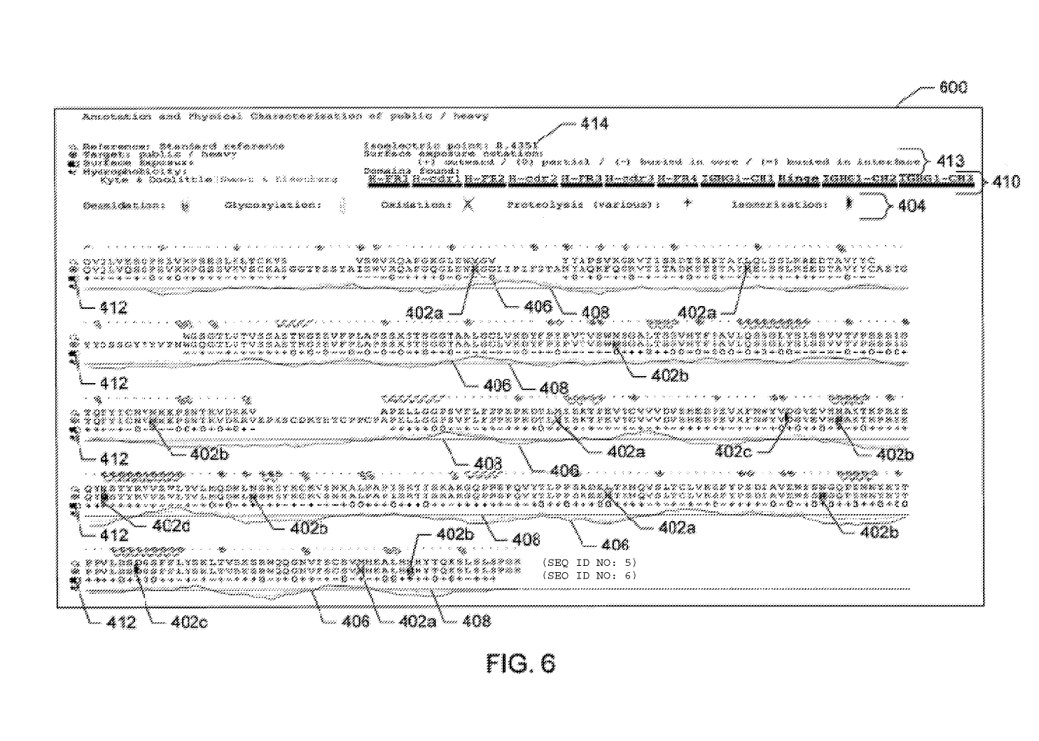

Yet another screen shot 600 of an example user interface for displaying alphabetic strings and associated chemical property predictions is shown in FIG. 6. In this example, several glyphs 402 are used to indicate different sites in the example amino acid sequence likely to be associated with different chemical properties 404 including oxidation 402a, deamidation 402b, isomerization 402c, and glycosylation 402d. Again, a hydrophobicity graph 406 plotted along a center line 408 and adjacent to the alphabetic string is shown. In addition, a region key 410 indicates a color that is associated with each region, and that color is then used for the portion of the alphabetic string associated with that region. Like the example of FIG. 4, the example of FIG. 6 includes a surface exposure row 412, which includes a symbol for each amino acid site indicative of a level of surface accessibility of the represented amino acid position. The example of FIG. 6 also includes an isoelectric point 414 associated with the amino acid sequence that may be based on the surface exposure.

An engineer working with an amino acid sequence may use one set of information visually represented on the screen 400 in conjunction with another set of information visually represented on the screen 400. For example, the surface exposure symbols 412 may be used in conjunction with the hydrophobicity graph 406. In the example of FIG. 4, an area 416 shows a portion of the amino acid sequence that has a high hydrophobicity (e.g., a sticky portion) and outward to partially outward surface exposure. This is typically considered an undesirable quality because it promotes protein aggregation (e.g., proteins that stick together in globs that are difficult to combine). Another area 418 shows a portion of the amino acid sequence that has a high hydrophobicity (e.g., a sticky portion) and buried surface exposure. This is typically considered a desirable quality because it creates a more stable structure. FIG. 8 is a close up view of another example showing a high hydrophobicity sequence in combination with a buried surface exposure. FIG. 9 is a close up view of an example showing a low hydrophobicity sequence (e.g., a non-sticky portion) in combination with an outward and buried surface exposure.

It will be appreciated that the process 300 may include a step of producing one or more of the amino acid sequences represented by the alphabetic strings. By producing an amino acid sequence, it is meant that a recombinant polypeptide is produced comprising the amino acid sequence represented by the alphabetic string. For the production of a recombinant polypeptide having an amino acid sequence represented by an alphabetic string, an isoelectric point displayed for the alphabetic string (see above) may be used, including for purification and/or formulation of the recombinant polypeptide. Such an isoelectric point may be used to select and utilize one or more buffers in the purification of the polypeptide, wherein the pH of the buffer(s) is not equal to the displayed isoelectric point. Such an isoelectric point may also be used to prepare a formulation of the polypeptide, wherein the pH of the formulation is not equal to the displayed isoelectric point.

In referring to a pH “not equal to” the calculated isoelectric point, the present disclosure contemplates that a range of pH values may be utilized which differ (e.g., greater than, less than) from the calculated isoelectric point. For example, a pH “not equal to” the calculated isoelectric point may represent a numerical difference in pH values (e.g., 6.5 versus 6.0), a functional difference in protein solubility (e.g., when selecting a buffer for purification of a protein and/or preparing a formulation of a protein), or preferably both. Preferably, the pH should differ from (e.g., not equal to) the calculated isoelectric point, so as to reduce or prevent aggregation or precipitation of the protein, such as for example in selecting a buffer for purification of the protein and/or preparing a formulation of the protein.

In some embodiments, the pH may be at least about 0.2 pH units, at least about 0.3 pH units, at least about 0.4 pH units, at least about 0.5 pH units, at least about 0.6 pH units, at least about 0.7 pH units, at least about 0.8 pH units, at least about 0.9 pH units, at least about 1.0 pH units, at least about 1.2 pH units, at least about 1.5 pH units, or at least about 2.0 pH units greater than or less than the calculated isoelectric point as disclosed herein. Alternatively or in addition, in some embodiments, the pH may be at least about 2%, at least about 3%, at least about 4%, at least about 5%, at least about 6%, at least about 7%, at least about 8%, at least about 9%, at least about 10%, at least about 12%, at least about 15%, or at least about 20% greater than or less than the calculated isoelectric point as disclosed herein.

The recombinant polypeptide may be produced as a polypeptide comprising only those amino acid residues identified in the display of the alphabetic string (e.g., a variable region sequence), or alternatively the amino acid residues identified in the display of the alphabetic string may be produced as part of a larger polypeptide, such as for example an immunoglobulin light chain or heavy chain. Further, the recombinant polypeptide may be produced alone or with one or more additional polypeptides, such as for example, an additional immunoglobulin light chain or fragment thereof, or additional immunoglobulin heavy chain or fragment thereof. By producing one or more such additional such polypeptides with the recombinant polypeptide comprising the amino acid sequence represented by the alphabetic string, a complete immunoglobulin molecule (e.g., binding antibody) that includes two full length heavy chains and two full length light chains may be produced.

Alternatively, or in addition, antibody fragments that retain binding activity may be produced. Antibody fragments are portions of an intact full length antibody, such as an antigen binding or variable region of the intact antibody. Examples of antibody fragments include Fab, Fab', F(ab′)2, and Fv fragments; diabodies; linear antibodies; single-chain antibody molecules (e.g., scFv); multispecific antibody fragments such as bispecific, trispecific, and multispecific antibodies (e.g., diabodies, triabodies, tetrabodies); minibodies; chelating recombinant antibodies; tribodies or bibodies; intrabodies; nanobodies; domain antibodies, small modular immunopharmaceuticals (SMIP), adnectins, binding-domain immunoglobulin fusion proteins; camelized antibodies; VHH containing antibodies; and any other polypeptides formed from antibody fragments.

Any number of methods commonly known in the art can be used to produce the aforementioned polypeptides. Recombinant DNA technology is a common production method of choice in which one or more expression vectors (e.g., vector constructs) comprising a nucleotide sequence encoding the aforementioned polypeptide(s) is used to produce the polypeptide(s) in a host cell, such as for example a bacterial or eukaryotic (e.g., yeast, mammalian) host cell. Non-limiting examples of such methods of producing the polypeptide(s) include those described in U.S. Pat. Nos. 4,816,567, 5,869,619, 6,331,415, and 7,192,737, US Application 20060121604, Antibody Engineering, The practical approach series, J. McCafferty, H. R. Hoogenboom, and D. J. Chiswell, editors, Oxford University Press, (1996), Wurm et al., Curr. Opn. Biotech. 10: 156-159 (1999), Durocher et al., Nucleic Acids Res. 30: 1-9 (2002); Meissner et al., Biotechnol. Bioeng. 75: 197-203 (2000); and Cote et al., Biotechnol. Bioeng. 59: 567-575 (1998), each of which are herein incorporated by reference in their entirety.

In summary, persons of ordinary skill in the art will readily appreciate that methods and apparatus for displaying alphabetic strings, such as alphabetic strings representing amino acid sequences of antibodies, have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A system for displaying predicted sites for modification in an amino acid sequence of an antibody, the system comprising:
a processor;
an input device operatively coupled to the processor;
an output device operatively coupled to the processor; and
a memory device operatively coupled to the processor, the memory device storing a software program to cause the processor to:
receive an alphabetic string indicative of a plurality of amino acids in a plurality of positions;
execute software instructions, the software instructions determining a presence or an absence of one or more positions in the plurality of positions that is associated with a first predicted chemical property and a second predicted chemical property, the first predicted chemical property including at least one of a deamidation, a glycosylation, an oxidation, a proteolysis, and an isomerization, the second predicted chemical property including at least one of the oxidation, the proteolysis, and the isomerization;
display the alphabetic string; and
graphically indicate the at least one position in association with the alphabetic string, if the at least one position is present in the plurality of positions.

2. The system of claim 1, wherein the software instructions determine a presence or an absence of one or more positions in the plurality of positions that is associated with a third predicted chemical property including at least one of a surface exposure and a hydrophobicity, and the third predicted chemical property is graphically indicated in association with the at least one position of the alphabetic string, if the at least one position is present in the plurality of positions.

3. The system of claim 1, wherein graphically indicating the at least one position includes overlaying an alphabetic character representing an amino acid at the at least one position with a semitransparent glyph.

4. The system of claim 1, wherein graphically indicating the at least one position includes overlaying an alphabetic character representing an amino acid at the at least one position with a first semitransparent glyph having a first shape and a second semitransparent glyph having a second shape, the first glyph being indicative of one of the predicted deamidation site, the predicted glycosylation site, the predicted oxidation site, the predicted proteolysis site, and the predicted isomerization site, the second glyph being indicative of another of the predicted deamidation site, the predicted glycosylation site, the predicted oxidation site, the predicted proteolysis site, and the predicted isomerization site, the first shape being different than the second shape.

5. (canceled)

6. The system of claim 1, wherein graphically indicating the at least one position includes overlaying an alphabetic character representing an amino acid at the at least one position with a first semitransparent glyph having a first color and a second semitransparent glyph having a second color, the first glyph being indicative of one of the predicted deamidation site, the predicted glycosylation site, the predicted oxidation site, the predicted proteolysis site, and the predicted isomerization site, the second glyph being indicative of another of the predicted deamidation site, the predicted glycosylation site, the predicted oxidation site, the predicted proteolysis site, and the predicted isomerization site, the first color being different than the second color.

7. The system of claim 1, wherein determining the presence or the absence of the at least one position includes using at least one regular expression.

8. The system of claim 1, wherein the processor displays a graph indicative of a chemical property adjacent to the alphabetic string.

9. The system of claim 1, wherein the processor displays data indicative of hydrophobicity.

10. The system of claim 1, wherein the processor displays a graph indicative of hydrophobicity.

11-13. (canceled)

14. The system of claim 1, wherein the processor visually codes sections of the alphabetic string to indicate different domains.

15-20. (canceled)

21. The system of claim 1, wherein the processor visually codes sections of the alphabetic string to indicate different binding sites.

22-26. (canceled)

27. The system of claim 1, wherein the alphabetic string includes at least a portion that represents a variable region of a heavy chain of the antibody.

28. The system of claim 1, wherein the alphabetic string includes at least a portion that represents a constant region of a heavy chain of the antibody.

29. The system of claim 1, wherein the alphabetic string includes at least a portion that represents a variable region of a light chain of the antibody.

30. The system of claim 1, wherein the alphabetic string includes at least a portion that represents a constant region of a light chain of the antibody.

31. (canceled)

32. The system of claim 1, wherein the processor displays an indication of surface exposure.

33-34. (canceled)

35. The system of claim 1, further comprising:
identifying a first plurality of amino acids in the amino acid sequence that are near a surface of the antibody;
identifying a second plurality of amino acids in the amino acid sequence that are not near the surface of the antibody;
calculating an isoelectric point using the first plurality of amino acids and not the second plurality of amino acids; and
displaying the calculated isoelectric point.

36. A system for displaying predicted sites for modification in an amino acid sequence of an antibody, the system comprising:
a processor;
an input device operatively coupled to the processor;
an output device operatively coupled to the processor; and
a memory device operatively coupled to the processor, the memory device storing a software program to cause the processor to:
receive an alphabetic string indicative of a plurality of amino acids in a plurality of positions;
execute software instructions, the software instructions determining a presence or an absence of one or more positions in the plurality of positions that is associated with at least two predicted chemical properties, the chemical properties including a deamidation, a glycosylation, an oxidation, a proteolysis, and an isomerization;
display the alphabetic string; and
graphically indicate the at least one position in association with the alphabetic string, if the at least one position is present in the plurality of positions, wherein graphically indicating the at least one position includes overlaying an alphabetic character representing an amino acid at the at least one position with a first semitransparent glyph having a first shape and a second semitransparent glyph having a second shape, the first shape being different than the second shape.

37-67. (canceled)

68. The system of claim 36, further comprising:
identifying a first plurality of amino acids in the amino acid sequence that are near a surface of the antibody;
identifying a second plurality of amino acids in the amino acid sequence that are not near the surface of the antibody;
calculating an isoelectric point using the first plurality of amino acids and not the second plurality of amino acids; and
displaying the calculated isoelectric point.

69. A system for displaying an isoelectric point associated with an amino acid sequence of an antibody, the system comprising:
a processor;
an input device operatively coupled to the processor;
an output device operatively coupled to the processor; and
a memory device operatively coupled to the processor, the memory device storing a software program to cause the processor to:
identify a first subset of amino acids from a plurality of amino acids in the amino acid sequence that are near a surface of the antibody;
identify a second subset of amino acids from the plurality of amino acids in the amino acid sequence that are not near the surface of the antibody;
calculate the isoelectric point using the first subset of amino acids and not the second subset of amino acids; and
display the calculated isoelectric point.

70. The system of claim 69, wherein the processor displays an indication of surface exposure.

71-72. (canceled)

73. The system of claim 69, wherein the processor displays predicted sites for modification in the amino acid sequence of the antibody by:
receiving an alphabetic string indicative of the plurality of amino acids in a plurality of positions;
executing software instructions, the software instructions determining a presence or an absence of one or more positions in the plurality of positions that is associated with a first predicted chemical property and a second predicted chemical property, the first predicted chemical property including at least one of a deamidation, a glycosylation, an oxidation, a proteolysis, and an isomerization, the second predicted chemical property including at least one of the oxidation, the proteolysis, and the isomerization;
displaying the alphabetic string; and
graphically indicating the at least one position in association with the alphabetic string, if the at least one position is present in the plurality of positions.

74-98. (canceled)

99. The system of claim 73, wherein the alphabetic string includes at least a portion that represents a variable region of a heavy chain of the antibody, at least a portion that represents a constant region of a heavy chain of the antibody, at least a portion that represents a variable region of a light chain of the antibody, or at least a portion that represents a constant region of a light chain of the antibody.

100-103. (canceled)

104. The system of claim 73, wherein the processor displays an indication of surface exposure.

105-321. (canceled)


SEQUENCE LISTING (11 sequences)

SEQ ID NO: 1 - protein, 198 aa, Artificial sequence
  Synthesized Reference kappa chain sequence
DIVLTQSPSSLSVSVGDRVTISCRASLAWYQQKPGKAPKLLIYSLESGVPSRFSGSGSGTDFTLTISSLQPEDFATYYCLTFGQGTKVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 2 - protein, 213 aa, Artificial sequence
  Synthesized Public kappa chain sequence
DVVMTQSPSSLSASVGDRVTITCQASQDISKYVNWYQQKPGRAPKLLIYEASNLETGVPPRFSGSGSGTHFSFTITGLQPEDIATYYCQQCDSLPPVFGQGTKLEVKTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 3 - protein, 196 aa, Artificial sequence
  Synthesized Reference lambda chain sequence
QSVLTQPPSVSGSPGQTVTISCTGSVSWYQQKPGQAPKLVIYKRPSGIPERFSGSKSGNTASLTISGLQAEDEADYYCVFGGGTKLTVLGTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 4 - protein, 216 aa, Artificial sequence
  Synthesized Public lambda chain sequence
QSVLTQPPSVSAAPGQKVTISCSGSSSNIGKNYVSWYQQLPGAAPKLLIYESDKRPSGIPDRFSGSKSGTSATLGITGLQTGDEAAYYCGTWDHSLNAGVFGGGTTLTVLTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 5 - protein, 406 aa, Artificial sequence
  Synthesized Reference heavy chain sequence
QVQLVESGPELVKPSESLKLTCKVSVSWVRQAPGKGLEWVGVYYAPSVKGRVTISRDTSKNTAYLQLSSLRAEDTAVYYCWGSGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVAPELLGGPSVFLFPPKPKDTLMISRTPEVTCVVVDVSHEDPEVKFNWYVDGVEVHNAKTKPREEQYNSTYRVVSVLTVLHQDWLNGKEYKCKVSNKALPAPIEKTISKAKGQPREPQVYTLPPSRDELTKNQVSLTCLVKGFYPSDIAVEWESKGQPENNYKTTPPVLDSDGSFFLYSKLTVDKSRWQQGNVFSCSVMHEALHNHYTQKSLSLSPGK

SEQ ID NO: 6 - protein, 453 aa, Artificial sequence
  Synthesized Public heavy chain sequence
QVQLVQSGPEVKKPGSSVKVSCKASGGTFSSYAISWVRQAPGQGLEWMGGIIPIFGTANYAQKFQGRVTITADKSTSTAYMELSSLRSEDTAVYYCASTGYYDSSGYYYVPNWGQGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKRVEPKSCDKTHTCPPCPAPELLGGPSVFLFPPKPKDTLMISRTPEVTCVVVDVSHEDPEVKFNWYVDGVEVHNAKTKPREEQYNSTYRVVSVLTVLHQDWLNGKEYKCKVSNKALPAPIEKTISKAKGQPREPQVYTLPPSREEMTKNQVSLTCLVKGFYPSDIAVEWESNGQPENNYKTTPPVLDSDGSFFLYSKLTVDKSRWQQGNVFSCSVMHEALHNHYTQKSLSLSPGK

SEQ ID NO: 7 - protein, 4 aa, Artificial sequence
  Synthesized Glyph 1
RASL

SEQ ID NO: 8 - protein, 14 aa, Artificial sequence
  Synthesized Glyph 2
QASQDIMAPLSKYV

SEQ ID NO: 9 - protein, 29 aa, Artificial sequence
  Synthesized high hydrophobic sequence
PSVFIFPPSDEQLKSGTASVVCLLNNFYP

SEQ ID NO: 10 - protein, 17 aa, Artificial sequence
  Synthesized low hydrophobic sequence 1
LAWYQQKPGKAPKLLIY

SEQ ID NO: 11 - protein, 17 aa, Artificial sequence
  Synthesized low hydrophobic sequence 2
IHWYQQKTDQAPKLLIK